(19) United States
(12) Patent Application Publication
(10) Pub. No.: US 2026/0337477 A1
(43) Pub. Date: Oct. 29, 2026

(54) SALT-RESISTANT GUAR GUM FRACTURING FLUID CROSS-LINKER AQUEOUS SOLUTION, PREPARATION METHOD THEREFOR, AND USE THEREOF

(71) Applicants: CHINA UNIVERSITY OF PETROLEUM, Qingdao (CN); QINGDAO CHINA UNIVERSITY OF PETROLEUM EDUCATION DEVELOPMENT CO., LTD, Qingdao (CN); SHIHEZI UNIVERSITY, Shihezi (CN)

(72) Inventors: Binglin LI, Qingdao (CN); Jianmin MA, Qingdao (CN); Shaohua MA, Qingdao (CN); Dongdong LIU, Qingdao (CN); Xiaoyang ZHANG, Shihezi (CN); Huaibin ZHEN, Beijing (CN); Yuliang SU, Qingdao (CN); Binfei LI, Qingdao (CN); Chao ZHANG, Qingdao (CN); Qichao LV, Qingdao (CN); Fan BU, Qingdao (CN); Yangyang SHANG, Qingdao (CN); Hongjun HU, Qingdao (CN); Jun HUANG, Qingdao (CN)

(73) Assignees: CHINA UNIVERSITY OF PETROLEUM, Qingdao (CN); QINGDAO CHINA UNIVERSITY OF PETROLEUM EDUCATION DEVELOPMENT CO., LTD, Qingdao (CN); SHIHEZI UNIVERSITY, Shihezi (CN)

(21) Appl. No.: 19/696,442

(22) Filed: Jun. 3, 2026

Related U.S. Application Data
(63) Continuation of application No. PCT/CN2024/130361, filed on Nov. 7, 2024.

(30) Foreign Application Priority Data
Dec. 13, 2023 (CN) 202311703563.2

(51) Int. Cl. C09K 8/68; C08B 37/00; E21B 43/26

(52) U.S. Cl. CPC C09K 8/685; C08B 37/0096; E21B 43/26

(57) ABSTRACT

The present disclosure relates to the technical field of petrochemical industry, in particular to a salt-resistant guar gum fracturing fluid cross-linker aqueous solution, a preparation method therefor, and use thereof. A salt-resistant guar gum fracturing fluid cross-linker aqueous solution, comprising water and a salt-resistant guar gum fracturing fluid cross-linker prepared by reacting a flue gas desulfurization and denitrification product with an aminocarboxylate complexing agent-based epoxyalkylboronate, wherein the flue gas desulfurization and denitrification product introduces a quaternary ammonium group for the cross-linker, the quaternary ammonium group is connected to an aminocarboxylate complexing agent-based epoxyalkylboronate group via a short carbon chain, and a boron atom in the boronate group is connected to the short carbon chain to form a boron-carbon bond. In the salt-resistant guar gum fracturing fluid cross-linker aqueous solution provided by the present disclosure, the aminocarboxylate complexing agent-based alkenylboronate in the salt-resistant guar gum fracturing fluid cross-linker.

### CROSS-REFERENCE TO RELATED APPLICATIONS

The application claims priority to Chinese patent application No. 202311703563.2, filed on Dec. 13, 2023, the entire contents of which are incorporated herein by reference.

### TECHNICAL FIELD

The present disclosure relates to the technical field of petrochemical industry, in particular to a salt-resistant guar gum fracturing fluid cross-linker aqueous solution, a preparation method therefor, and use thereof.

### BACKGROUND

Fracturing technology is one of the essential measures for oil and gas field development. As an important constituent of fracturing technology, a fracturing fluid is the key to the success of fracturing.

Most existing common cross-linkers for guar gum are composed of borates, including borax, organic boron, etc. Organic boron has a large number of boronic acid groups, which play a role in cross-linking with guar gum. The boron atom is connected to an oxygen atom and a nitrogen atom. Although the chain length of the cross-linkers is prolonged, boron-oxygen bonds and boron-nitrogen bonds are prone to hydrolysis upon exposure to heat, acids, and alkalies, thus limiting the application of such cross-linkers under high-temperature reservoir and acidic and alkaline conditions. Common anti-swelling agents for guar gum fracturing fluids are inorganic salts such as KCl, which accordingly puts forward salt resistance requirements for guar gum. In order to reduce reservoir damage, it is necessary to use guar gum in combination with a microbicide. Therefore, developing a salt-, heat-, and alkali-resistant guar gum fracturing fluid cross-linker functioning as both an anti-swelling agent and a microbicide has become a relatively important topic.

### SUMMARY

The object of the present disclosure is to provide a salt-resistant guar gum fracturing fluid cross-linker aqueous solution, a preparation method therefor, and use thereof in order to overcome the above-mentioned deficiencies in the prior art. The cross-linker is prepared by reacting a desulfurization and denitrification product with an aminocarboxylate complexing agent-based epoxyalkylboronate and has good alkali stability and heat resistance. The aminocarboxylate complexing agent-based boronate group in the cross-linker is hydrolyzed upon contact with an alkali to generate an aminocarboxylate complexing agent, which coordinates with calcium and magnesium ions to achieve a high salinity resistance effect. The desulfurization and denitrification product introduces a quaternary ammonium group for the cross-linker. The nitrogen atom therein can act as both an anti-swelling agent and a microbicide, thereby achieving multiple functions with one agent.

In order to achieve the above-mentioned technical effects, the following technical solution is used in the present disclosure:
A salt-resistant guar gum fracturing fluid cross-linker aqueous solution, comprising water and a salt-resistant guar gum fracturing fluid cross-linker prepared by reacting a flue gas desulfurization and denitrification product with an aminocarboxylate complexing agent-based epoxyalkylboronate, wherein the flue gas desulfurization and denitrification product introduces a quaternary ammonium group for the cross-linker, the quaternary ammonium group is connected to an aminocarboxylate complexing agent-based epoxyalkylboronate group via a short carbon chain, and a boron atom in the boronate group is connected to the short carbon chain to form a boron-carbon bond;
specifically, the chemical formula of the salt-resistant guar gum fracturing fluid cross-linker is:

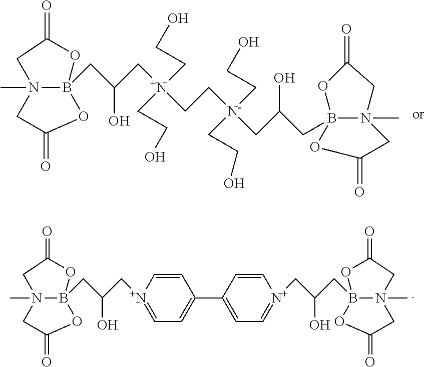

In the salt-resistant guar gum fracturing fluid cross-linker aqueous solution provided by the present disclosure, the aminocarboxylate complexing agent-based alkenylboronate in the salt-resistant guar gum fracturing fluid cross-linker, after being incorporated into the fracturing fluid, is hydrolyzed upon contact with an alkali to generate an aminocarboxylate complexing agent and a boronic acid functional group, wherein the aminocarboxylate complexing agent can coordinate with magnesium ions in a reservoir to achieve a salinity resistance effect, and the boronic acid group provides the cross-linker with a delayed cross-linking effect. The boron atom in the boronic acid group is connected to the short carbon chain to form a boron-carbon bond, which exhibits higher alkali stability and heat resistance than boron-nitrogen bonds and boron-oxygen bonds in existing common boron-containing cross-linkers. In addition, the nitrogen atom in the flue gas desulfurization and denitrification product provides the cross-linker with the functions of both an anti-swelling agent and a microbicide, thus achieving multiple functions with one agent.

The present disclosure further provides a method for preparing the above-mentioned salt-resistant guar gum fracturing fluid cross-linker aqueous solution, comprising the following steps:
S1. treatment of aminocarboxylate complexing agent-based alkenylboronate: adding an aminocarboxylate complexing agent-based alkenylboronate to a polar organic solvent, stirring and cooling the mixture to obtain a suspension, adding peracetic acid to the suspension, heating and stirring the suspension to obtain a mixture, separating an organic phase, and subjecting the organic phase to drying, filtration, concentration under vacuum, and then purification by passing through a chromatographic column to obtain a desired crystalline solid, namely an aminocarboxylate complexing agent-based epoxyalkylboronate; and
S2. stirring and heating a flue gas desulfurization and denitrification product, then adding the crystalline solid prepared in step S1, dropwise adding deionized water, and reacting the mixture while the temperature is maintained to obtain the salt-resistant guar gum fracturing fluid cross-linker aqueous solution, wherein
the flue gas desulfurization and denitrification product is one of THEED (tetrakis(hydroxyethyl)ethylenediamine) sulfate, THEED nitrate, bipy (4,4′-bipyridine) sulfate, or bipy nitrate;
the aminocarboxylate complexing agent-based alkenylboronate is selected from allylboronic acid N-methyliminodiacetic acid ester; and
the molar ratio of the flue gas desulfurization and denitrification product to the aminocarboxylate complexing agent-based epoxyalkylboronate is 1:2.

In the preparation method provided by the present disclosure, firstly, allylboronic acid N-methyliminodiacetic acid ester is treated with peracetic acid, and the specific reaction formula is as follows:

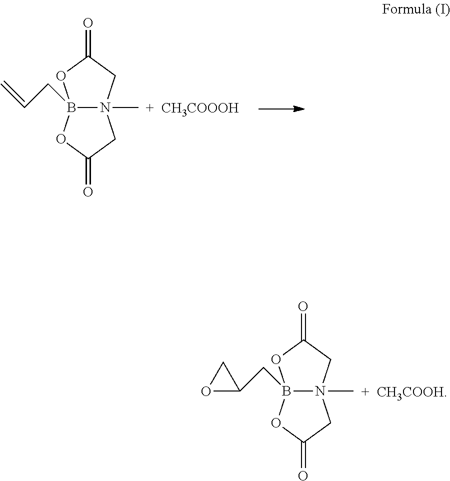

The aminocarboxylate complexing agent in the aminocarboxylate complexing agent-based alkenylboronate may be selected from not only the above-mentioned N-methyliminodiacetic acid (MIDA), but also from other common aminocarboxylate complexing agents, such as sodium ferrocenylmethyliminodiacetate (FIDA), ethylenediaminetetraacetic acid (EDTA), propylenediaminetetraacetic acid (PDTA), diethylenetriaminepentaacetic acid (DTPA), triethylenetetraminehexaacetic acid (TTHA), or other common aminocarboxylate complexing agents.

Preferably, in step S1, the polar organic solvent is selected from dichloromethane. Further preferably, the ratio of the polar organic solvent to the aminocarboxylate complexing agent-based alkenylboronate is (15-25) L: 1 mol.

Preferably, in step S1, the temperature of the suspension is −10° C. to 0° C.;
the molar ratio of the added peracetic acid to the added aminocarboxylate complexing agent-based alkenylboronate is (3-4): 1; and
the heating and stirring are specifically heating to 20° C. to 40° C. and stirring for 15 to 20 h.

Further preferably, the temperature of the suspension is 0° C.;
the molar ratio of the added peracetic acid to the added aminocarboxylate complexing agent-based alkenylboronate is 3:1; and
the heating and stirring are specifically heating to 23° C. and stirring for 18 h.

Preferably, in step S1, the specific operation of separating the organic phase comprises:
pouring the mixture into a separatory funnel containing a sodium bicarbonate solution, diluting the resulting mixed solution with ethyl acetate, then shaking the resulting dilution, separating an aqueous phase from an organic phase, extracting and separating the aqueous phase with ethyl acetate, and then washing the organic phase with a sodium bicarbonate solution.

Preferably, in step S1, a stationary phase in the chromatographic column is silica, and the solvent is a mixture of diethyl ether and acetonitrile at a volume ratio of 3:2.

Preferably, in step S2, stirring and heating to 25° C. to 50° C. are used, and the duration of the reaction at the maintained temperature is 0.5-3 h;
further preferably, stirring and heating to 35° C. are used, and the reaction is carried out at the maintained temperature for 2 h.

Preferably, in step S2, the prepared salt-resistant guar gum fracturing fluid cross-linker aqueous solution has a concentration of 100-700 mg/L, further preferably 500 mg/L.

The present disclosure further provides use of the above-mentioned salt-resistant guar gum fracturing fluid cross-linker aqueous solution or a salt-resistant guar gum fracturing fluid cross-linker aqueous solution prepared by the above-mentioned preparation method, wherein the salt-resistant guar gum fracturing fluid cross-linker aqueous solution is mixed with a guar gum fracturing fluid and injected into a formation, and the concentration of the salt-resistant guar gum fracturing fluid cross-linker in the salt-resistant guar gum fracturing fluid cross-linker aqueous solution is 100-700 mg/L.

Preferably, the concentration of the salt-resistant guar gum fracturing fluid cross-linker in the salt-resistant guar gum fracturing fluid cross-linker aqueous solution is 500 mg/L.

### Beneficial Effects of the Present Disclosure:

1. In the salt-resistant guar gum fracturing fluid cross-linker aqueous solution provided by the present disclosure, the aminocarboxylate complexing agent-based alkenylboronate, after being incorporated into the fracturing fluid, is hydrolyzed upon contact with an alkali to generate an aminocarboxylate complexing agent and a boronic acid functional group, wherein the aminocarboxylate complexing agent can coordinate with magnesium ions in a reservoir to achieve a salinity resistance effect, and the boronic acid group provides the cross-linker with a delayed cross-linking effect. The boron atom in the boronic acid group is connected to the short carbon chain to form a boron-carbon bond, which exhibits higher alkali stability and heat resistance than boron-nitrogen bonds and boron-oxygen bonds in existing common boron-containing cross-linkers. In addition, the nitrogen atom in the flue gas desulfurization and denitrification product introduces a quaternary ammonium group for the cross-linker, so that the cross-linker acts as both an anti-swelling agent and a microbicide, thus achieving multiple functions with one agent, avoiding the use of an inorganic salt anti-swelling agent, and reducing the salt resistance requirements of guar gum fracturing fluids.
2. The raw material of the present disclosure involves a flue gas desulfurization and denitrification product, thereby turning waste into treasure and effectively controlling the manufacturing cost of the cross-linker.

### BRIEF DESCRIPTION OF DRAWINGS

FIG. 1 is a graph plotting the relationship between the concentration of a cross-linker and the viscosity of guar gum in Experimental Example 2.

FIG. 2 is a graph plotting the relationship between the pH value of a fracturing fluid system and the viscosity of guar gum in Experimental Example 3.

FIG. 3 is a graph plotting the relationship between the temperature of a fracturing fluid system and the viscosity of guar gum in Experimental Example 4.

FIG. 4 is a graph plotting the relationship between the cross-linking time and the viscosity of guar gum in Experimental Example 5.

FIG. 5 is a graph plotting the relationship between the shear time and the viscosity of guar gum in Experimental Example 6.

FIG. 6 is a graph plotting the relationship between the salinity of a fracturing fluid system and the viscosity of guar gum in Experimental Example 7.

FIG. 7 is an infrared spectrum of a cross-linker in Example 2.

FIG. 8 is an infrared spectrum of a cross-linker in Example 4.

### DETAILED DESCRIPTION OF THE EMBODIMENTS

The present disclosure will be further illustrated below with reference to examples and drawings.

It should be noted that the experimental methods described in the following examples are all conventional methods unless otherwise specified; and the reagents, materials, and equipment can be obtained from commercial channels, unless otherwise specified.
1. Test method for anti-swelling rate: The anti-swelling performance of a cross-linker is determined according to SY/T 5971-2016 “The performance evaluation method of clay stabilizer for fracturing, acidizing and water injection in oil and gas fields”.
2. Test method of microbicidal rate: The microbicidal performance of the cross-linker is obtained according to a performance evaluation method for a microbicide for oil fields in Q/SW 050-2020 “Microbicides for oil fields”.
3. Performance evaluation of fracturing fluid: The slow cross-linking performance of an organic amine boron cross-linked fracturing fluid is determined according to SY/T 5107-2016 “The evaluation measurement for properties of water-based fracturing fluid”.

### Example 1

A salt-resistant guar gum fracturing fluid cross-linker aqueous solution, comprising water and a salt-resistant guar gum fracturing fluid cross-linker, wherein the salt-resistant guar gum fracturing fluid cross-linker was prepared by reacting THEED nitrate with allylboronic acid N-methyliminodiacetic acid ester. The chemical formula was as follows:

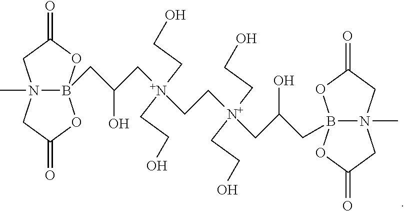

The above-mentioned salt-resistant guar gum fracturing fluid cross-linker aqueous solution was prepared by the following method:
S1. putting 1.00 mmol of allylboronic acid N-methyliminodiacetic acid ester and 20 mL of dichloromethane into a 50 mL Schlenk flask equipped with a stirring bar, stirring the mixture to obtain a suspension, then cooling the suspension to 0° C., adding 3 mmol of peracetic acid to the suspension, heating the resulting material to 23° C., and stirring the resulting material for 18 h to obtain a mixture; pouring the mixture into a separatory funnel containing 10 mL of a 0.05 mol/L sodium bicarbonate solution, diluting the resulting mixed solution with 40 mL of ethyl acetate, then shaking the resulting dilution, and separating an aqueous phase from an organic phase; extracting and separating the aqueous phase with 80 mL of ethyl acetate; and washing the remaining organic phase with 5 mL of a 0.05 mol/L sodium bicarbonate solution and subjecting the organic phase to drying over magnesium sulfate, filtration, concentration under vacuum, and then passage through a silica chromatographic column for purification by rapid chromatography with a mixed solution of diethyl ether and acetonitrile at a volume ratio of 3:2 to obtain 147 mg of a colorless epoxypropylboronic acid N-methyliminodiacetic acid ester crystalline solid; and
S2. preparing 0.5 mmol of THEED nitrate into an aqueous solution, stirring and heating the aqueous solution to 35° C., then adding the crystalline solid prepared in step S1, dropwise adding 20 mL of deionized water, and reacting the mixture for 2 h while the temperature was maintained at 35° C. to obtain the salt-resistant guar gum fracturing fluid cross-linker aqueous solution having a concentration of 500 mg/L.

In this example, the reaction involved in step S2 was as follows:

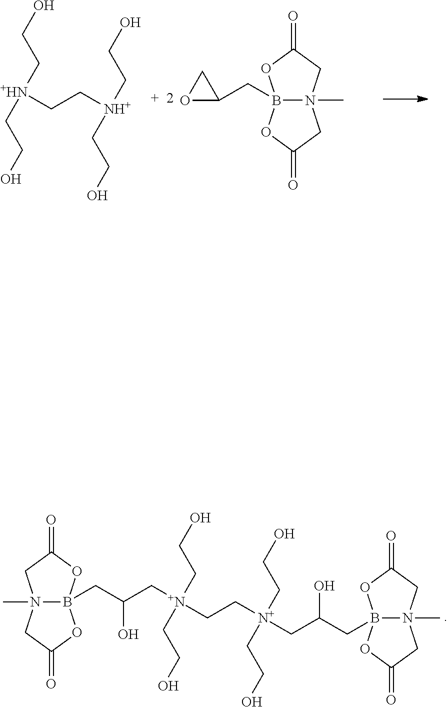

### Example 2

A salt-resistant guar gum fracturing fluid cross-linker aqueous solution, comprising water and a salt-resistant guar gum fracturing fluid cross-linker, wherein the salt-resistant guar gum fracturing fluid cross-linker was prepared by reacting THEED sulfate with allylboronic acid N-methyliminodiacetic acid ester. The chemical formula was the same as that in Example 1.

The above-mentioned salt-resistant guar gum fracturing fluid cross-linker aqueous solution was prepared by the following method:
S1. putting 1.00 mmol of allylboronic acid N-methyliminodiacetic acid ester and 15 mL of dichloromethane into a 50 mL Schlenk flask equipped with a stirring bar, stirring the mixture to obtain a suspension, then cooling the suspension to −10° C., adding 4 mmol of peracetic acid to the suspension, heating the resulting material to 20° C., and stirring the resulting material for 20 h to obtain a mixture; pouring the mixture into a separatory funnel containing 10 mL of a 0.05 mol/L sodium bicarbonate solution, diluting the resulting mixed solution with 40 mL of ethyl acetate, then shaking the resulting dilution, and separating an aqueous phase from an organic phase; extracting and separating the aqueous phase with 80 mL of ethyl acetate; and washing the remaining organic phase with 5 mL of a 0.05 mol/L sodium bicarbonate solution and subjecting the organic phase to drying over magnesium sulfate, filtration, concentration under vacuum, and then passage through a silica chromatographic column for purification by rapid chromatography with a mixed solution of diethyl ether and acetonitrile at a volume ratio of 3:2 to obtain 147 mg of a colorless epoxypropylboronic acid N-methyliminodiacetic acid ester crystalline solid; and
S2. preparing 0.5 mmol of THEED sulfate into an aqueous solution, stirring and heating the aqueous solution to 25° C., then adding the crystalline solid prepared in step S1, dropwise adding 20 mL of deionized water, and reacting the mixture for 3 h while the temperature was maintained at 25° C. to obtain the salt-resistant guar gum fracturing fluid cross-linker aqueous solution having a concentration of 500 mg/L.

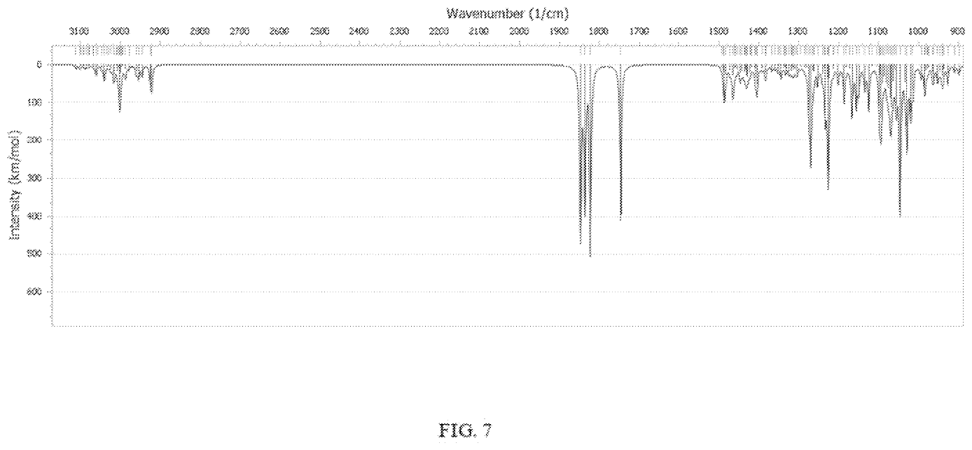

The infrared spectrum of the cross-linker is as shown in FIG. 7, in which the peak at 2959 cm⁻¹ corresponds to the boron-carbon bond between the boronate group and the short carbon chain, the peak between 3067 cm⁻¹ and 3079 cm⁻¹ corresponds to the cyclic structure of an MIDA boronate group, and the peak between 1304 cm⁻¹ and 1461 cm⁻¹ corresponds to a quaternary ammonium group between boron atoms.

### Example 3

A salt-resistant guar gum fracturing fluid cross-linker aqueous solution, comprising water and a salt-resistant guar gum fracturing fluid cross-linker, wherein the salt-resistant guar gum fracturing fluid cross-linker was prepared by reacting bipy sulfate with allylboronic acid N-methyliminodiacetic acid ester. The chemical formula was as follows:

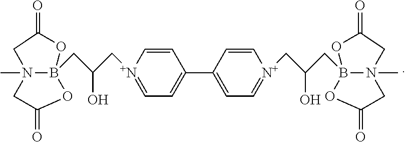

The above-mentioned salt-resistant guar gum fracturing fluid cross-linker aqueous solution was prepared by the following method:
S1. putting 1.00 mmol of allylboronic acid N-methyliminodiacetic acid ester and 20 mL of dichloromethane into a 50 mL Schlenk flask equipped with a stirring bar, stirring the mixture to obtain a suspension, then cooling the suspension to 0° C., adding 3 mmol of peracetic acid to the suspension, heating the resulting material to 23° C., and stirring the resulting material for 18 h to obtain a mixture; pouring the mixture into a separatory funnel containing 10 mL of a 0.05 mol/L sodium bicarbonate solution, diluting the resulting mixed solution with 40 mL of ethyl acetate, then shaking the resulting dilution, and separating an aqueous phase from an organic phase; extracting and separating the aqueous phase with 80 mL of ethyl acetate; and washing the remaining organic phase with 5 mL of a 0.05 mol/L sodium bicarbonate solution and subjecting the organic phase to drying over magnesium sulfate, filtration, concentration under vacuum, and then passage through a silica chromatographic column for purification by rapid chromatography with a mixed solution of diethyl ether and acetonitrile at a volume ratio of 3:2 to obtain 147 mg of a colorless epoxypropylboronic acid N-methyliminodiacetic acid ester crystalline solid; and
S2. preparing 0.5 mmol of bipy sulfate into an aqueous solution, stirring and heating the aqueous solution to 35° C., then adding the crystalline solid prepared in step S1, dropwise adding 20 mL of deionized water, and reacting the mixture for 2 h while the temperature was maintained at 35° C. to obtain the salt-resistant guar gum fracturing fluid cross-linker aqueous solution having a concentration of 500 mg/L.

In this example, the reaction involved in step S2 was as follows:

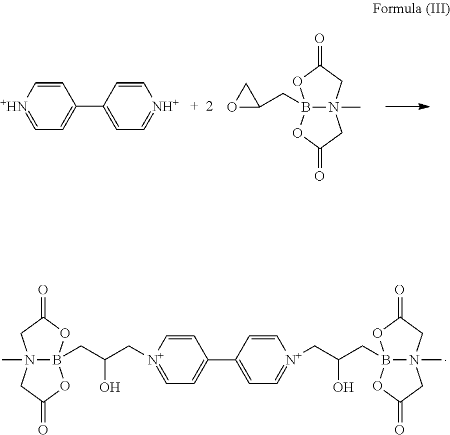

### Example 4

A salt-resistant guar gum fracturing fluid cross-linker aqueous solution, comprising water and a salt-resistant guar gum fracturing fluid cross-linker, wherein the salt-resistant guar gum fracturing fluid cross-linker was prepared by reacting bipy nitrate with allylboronic acid N-methyliminodiacetic acid ester. The chemical formula was the same as that in Example 2.

The above-mentioned salt-resistant guar gum fracturing fluid cross-linker aqueous solution was prepared by the following method:
S1. putting 1.00 mmol of allylboronic acid N-methyliminodiacetic acid ester and 15 mL of dichloromethane into a 50 mL Schlenk flask equipped with a stirring bar, stirring the mixture to obtain a suspension, then cooling the suspension to −5° C., adding 3.5 mmol of peracetic acid to the suspension, heating the resulting material to 40° C., and stirring the resulting material for 15 h to obtain a mixture; pouring the mixture into a separatory funnel containing 10 mL of a 0.05 mol/L sodium bicarbonate solution, diluting the resulting mixed solution with 40 mL of ethyl acetate, then shaking the resulting dilution, and separating an aqueous phase from an organic phase; extracting and separating the aqueous phase with 80 mL of ethyl acetate; and washing the remaining organic phase with 5 mL of a 0.05 mol/L sodium bicarbonate solution and subjecting the organic phase to drying over magnesium sulfate, filtration, concentration under vacuum, and then passage through a silica chromatographic column for purification by rapid chromatography with a mixed solution of diethyl ether and acetonitrile at a volume ratio of 3:2 to obtain 147 mg of a colorless epoxypropylboronic acid N-methyliminodiacetic acid ester crystalline solid; and
S2. preparing 0.5 mmol of bipy nitrate into an aqueous solution, stirring and heating the aqueous solution to 50° C., then adding the crystalline solid prepared in step S1, dropwise adding 20 mL of deionized water, and reacting the mixture for 0.5 h while the temperature was maintained at 50° C. to obtain the salt-resistant guar gum fracturing fluid cross-linker aqueous solution having a concentration of 500 mg/L.

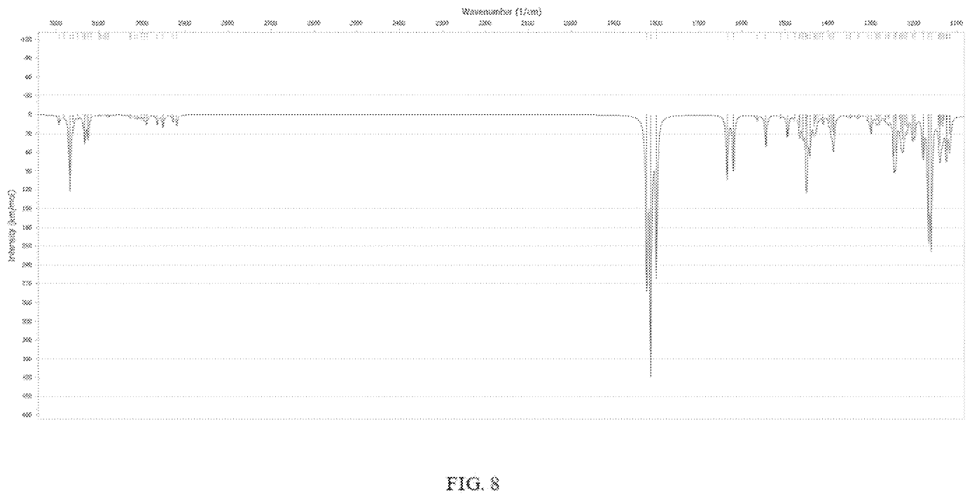

The infrared spectrum of the cross-linker is as shown in FIG. 8, in which the peak between 2928 cm⁻¹ and 2989 cm⁻¹ corresponds to the boron-carbon bond between the boronate group and the short carbon chain, the peak between 3016 cm⁻¹ and 3027 cm⁻¹ corresponds to the cyclic structure of an MIDA boronate group, and the peak between 1494 cm⁻¹ and 1635 cm⁻¹ corresponds to a pyridine ring between boron atoms.

### Example 5

Use of the salt-resistant guar gum fracturing fluid cross-linker aqueous solution as provided in any one of Examples 1-4, wherein the salt-resistant guar gum fracturing fluid cross-linker aqueous solution was mixed with a guar gum fracturing fluid and injected into a formation.

After the salt-resistant guar gum fracturing fluid cross-linker aqueous solution was mixed with the guar gum fracturing fluid, the salt-resistant guar gum fracturing fluid cross-linker was hydrolyzed upon contact with an alkali to obtain a boronic acid group and MIDA. MIDA could chelate with calcium and magnesium ions in the formation to promote the shift of the hydrolysis equilibrium to the right, thereby better improving the effects of salinity resistance and delayed cross-linking performance of the fracturing fluid. The reaction formula was as follows:

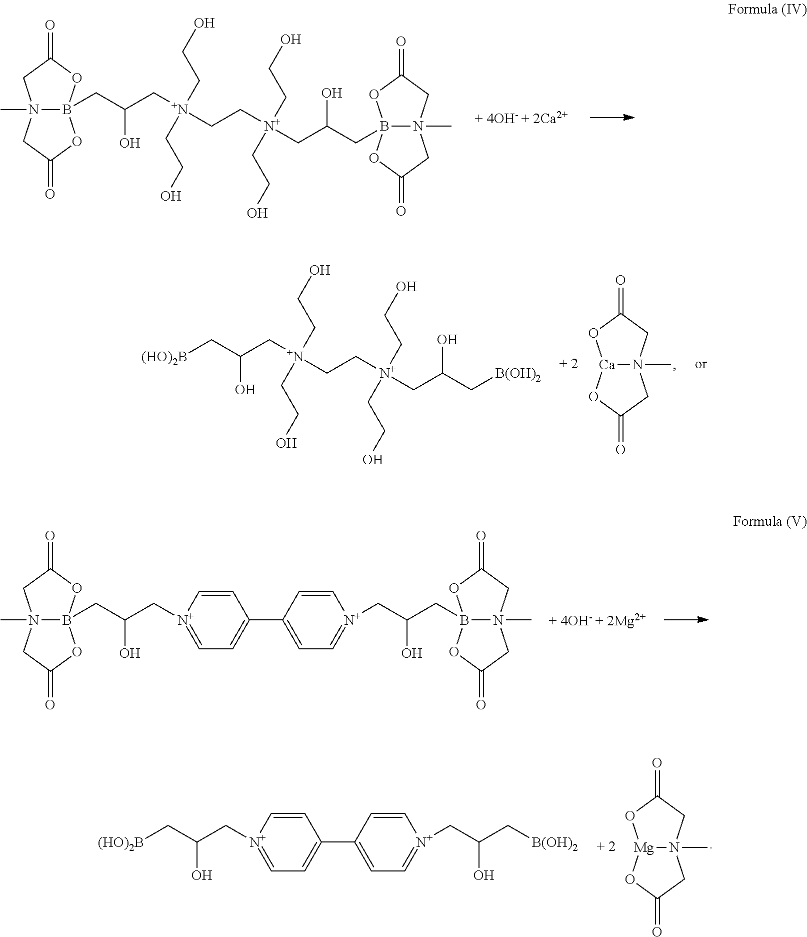

Formula (IV) shows the reaction principle of the salt-resistant guar gum fracturing fluid cross-linker aqueous solution provided in Example 1 or 2, and Formula (V) shows the reaction principle of the salt-resistant guar gum fracturing fluid cross-linker aqueous solution provided in Example 3 or 4.

### Experimental Example 1

The salt-resistant guar gum fracturing fluid cross-linker aqueous solutions prepared in Example 2 and 4 and an aqueous solution prepared from a cross-linker provided by “Synthesis and Application of Organic Amine Boron Cross-linker AB-1” were respectively cross-linked with guar gum. The pH values of fracturing fluid systems composed of the cross-linker aqueous solutions and guar gum were both 12. The cross-linker aqueous solutions all had a mass concentration of 500 mg/L, and the concentration of guar gum was 5000 mg/L. KCl with a mass concentration of 4% as an anti-swelling agent and glutaraldehyde with a mass concentration of 1% as a microbicide were also added to the fracturing fluid system of the cross-linker provided by “Synthesis and Application of Organic Amine Boron Crosslinker AB-1”, as Comparative Example 1.

The anti-swelling rate and microbicidal rate of the above-mentioned fracturing fluid were measured. The results are as shown in Table 1:

TABLE 1
Anti-swelling rate and microbicidal rate of each group

| | Microbicidal rate/% | Anti-swelling rate/% |
|---|---|---|
| Example 2 | 99 | 81 |
| Example 4 | 97 | 79 |
| Comparative Example 1 | 74 | 55 |

As can be seen from the table, the microbicidal rate of Example 2 is higher than that of Comparative Example 1 by 33.8%, and the anti-swelling rate is higher than that of Comparative Example 1 by 47.3%. The microbicidal rate of Example 4 is higher than that of Comparative Example 1 by 31.1%, and the anti-swelling rate is higher than that of Comparative Example 1 by 43.6%. Introducing the quaternary ammonium functional group into the cross-linker can effectively provide both anti-swelling and microbicidal effects, which not only achieves multiple functions with one agent and the effect of reduced costs, without the need for the additional addition of an anti-swelling agent and a microbicide, but also reduces the salt resistance and compatibility requirements of guar gum.

### Experimental Example 2

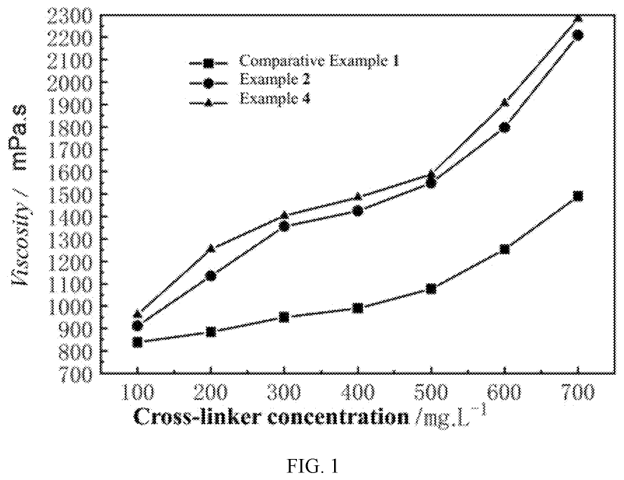

I. Purpose of experiment: The effect of the concentration of a cross-linker on the performance of the cross-linker was investigated.
II. Experimental method: On the basis of Example 2, Example 4, and Comparative Example 1, the concentration of the cross-linker was changed, and the preparation method for the fracturing fluid system was the same as that of Example 2, Example 4, and Comparative Example 1 in the experimental examples.
III. Experimental results: As shown in FIG. 1. When the concentration of the cross-linker is 500 mg/L, the viscosity of the fracturing fluid increases significantly with the concentration. The viscosity of the fracturing fluid in Example 2 is higher than Comparative Example 1 by 43.9%, and the viscosity of the fracturing fluid in Example 4 is higher than Comparative Example 1 by 47.4%. The molecular chain of the cross-linker in the present disclosure is relatively long, which can better achieve the cross-linking effect. However, considering economy and safety issues at the fracturing site, the concentration of the cross-linker is preferably 500 mg/L.

### Experimental Example 3

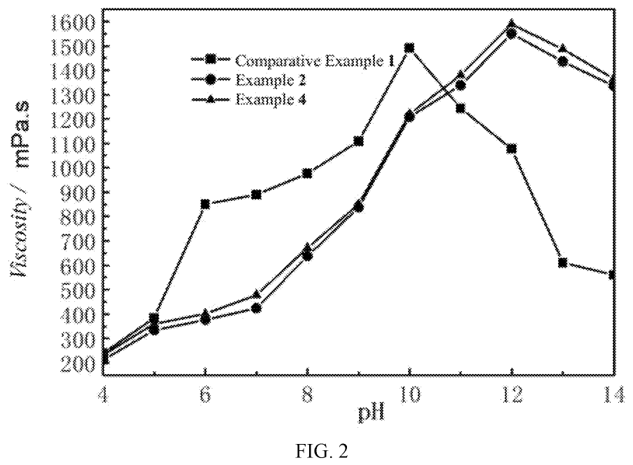

I. Purpose of experiment: The effect of the pH value on the performance of the cross-linker was investigated.
II. Experimental method: On the basis of Example 2, Example 4, and Comparative Example 1, the pH value was changed, and the preparation method for the fracturing fluid system was the same as that of Example 2, Example 4, and Comparative Example 1 in the experimental examples.
III. Experimental results: As shown in FIG. 2. In the present disclosure, the viscosity of the fracturing fluid obtained using the cross-linker at pH=12 reaches the maximum, the extent of viscosity decrease as the pH value increases is less than that of Comparative Example 1, and Comparative Example 1 achieves the maximum viscosity of the fracturing fluid at pH=10. In the present disclosure, the carbon-nitrogen chain between boron atoms is more resistant to alkaline hydrolysis than Comparative Example 1. The present disclosure can under hydrolysis in a relatively strong alkaline environment to generate a boronic acid group that cross-links with guar gum, so the alkali resistance is stronger. The optimal pH value of cross-linking is 12.

### Experimental Example 4

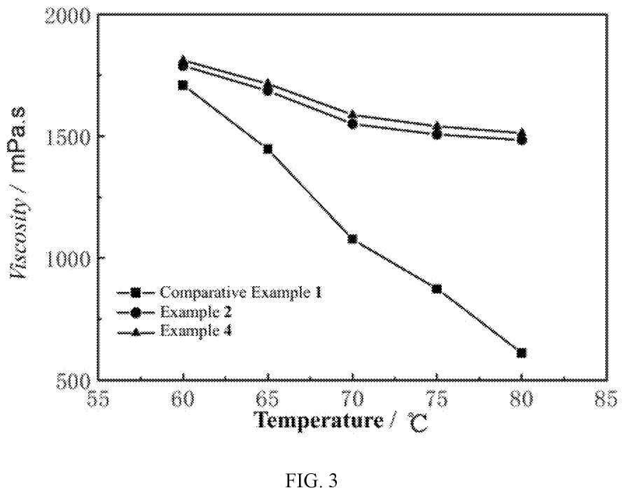

I. Purpose of experiment: The effect of the temperature on the performance of the cross-linker was investigated.
II. Experimental method: On the basis of Example 2, Example 4, and Comparative Example 1, the temperature was changed, and the preparation method for the fracturing fluid system was the same as that of Example 2, Example 4, and Comparative Example 1 in the experimental examples.
III. Experimental results: As shown in FIG. 3. The extent of viscosity decrease of the fracturing fluid when using the cross-linker of the present disclosure is lower than Comparative Example 1. The carbon-nitrogen chain between boron atoms in the present disclosure is more difficult to hydrolyze under heat than Comparative Example 1. When the temperature exceeds 70° C., a large number of boronic acid groups generated by the hydrolysis of the cross-linker cross-link with guar gum, and the rate at which the viscosity decreases with temperature becomes slow.

### Experimental Example 5

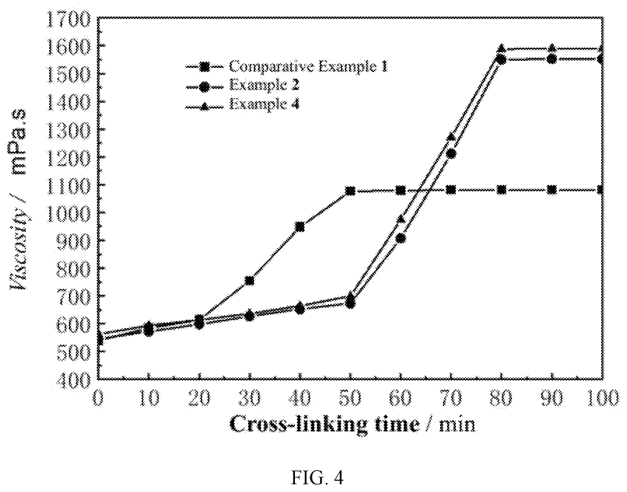

I. Purpose of experiment: The delayed cross-linking performance was investigated.
II. Experimental method: On the basis of Example 2, Example 4, and Comparative Example 1, the concentration of guar gum at different cross-linking times was determined, and the preparation method for the fracturing fluid system was the same as that of Example 2, Example 4, and Comparative Example 1 in the experimental examples.
III. Experimental results: As shown in FIG. 4. The viscosity of the fracturing fluid in Comparative Example 1 increases significantly from 20 minutes and reaches the maximum at 50 minutes. The viscosity of the fracturing fluid in the present disclosure increases significantly from 50 minutes and reaches the maximum at 80 minutes, which is delayed by 30 minutes as compared with Comparative Example 1. In the present disclosure, the boron atom of the cross-linker is closely complexed with MIDA, and it takes a relatively long time to dissociate a boronic acid group, thus better realizing delayed cross-linking.

### Experimental Example 6

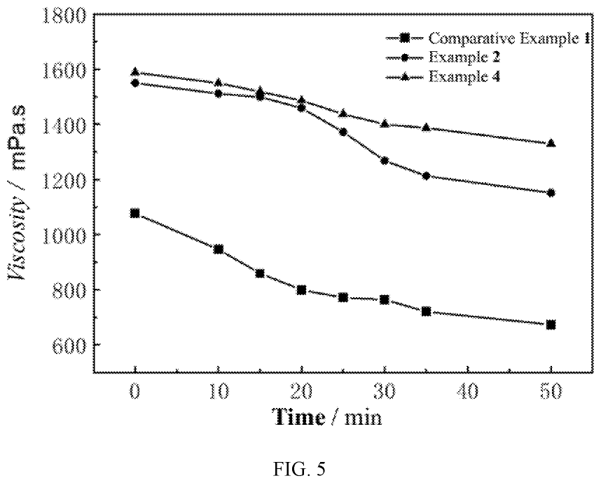

I. Purpose of experiment: The effect of the shear time on the performance of the cross-linker was investigated.
II. Experimental method: On the basis of Example 2, Example 4, and Comparative Example 1, the concentration of guar gum at different shear times was determined, and the preparation method for the fracturing fluid system was the same as that of Example 2, Example 4, and Comparative Example 1 in the experimental examples.
III. Experimental results: As shown in FIG. 5. After shearing for 50 min, the viscosity in Comparative Example 1 decreases to 62.5%, the viscosity in Example 2 decreases to 74.3%, and the viscosity in Example 4 decreases to 83.8%. This is because the cross-linker prepared in Example 4 has a pyridine functional group, which results in a stronger molecular rigidity, so the shear resistance is better than that of Example 2 and the extent of viscosity decrease of the fracturing fluid system is smaller. Therefore, the cross-linker in Example 4 is preferred.

### Experimental Example 7

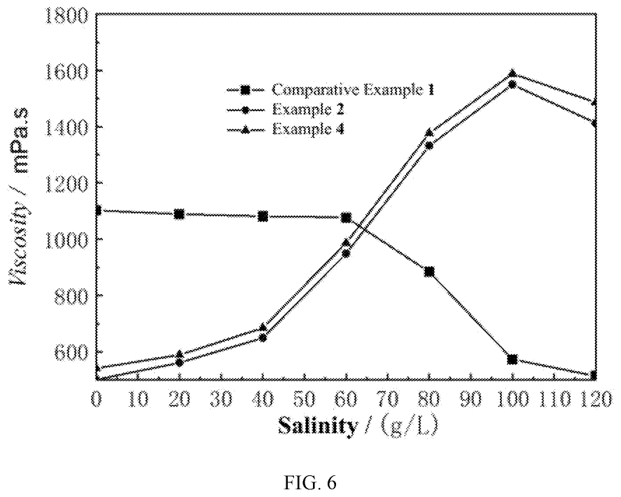

I. Purpose of experiment: The effect of the salinity on the performance of the cross-linker was investigated.
II. Experimental method: Formation water was prepared according to the water quality of C-1 in oilfield S. On the basis of Example 2, Example 4, and Comparative Example 1, the salinity of the solution was changed, and the preparation method for the fracturing fluid system was the same as that of Example 2, Example 4, and Comparative Example 1 in the experimental examples.
III. Experimental results: As shown in FIG. 6. When the salinity of the fracturing fluid system is less than 100 g/L, the viscosity of the fracturing fluid in Comparative Example 1 decreases with the salinity, whereas the viscosity of the fracturing fluid in the present disclosure increases with the salinity. MIDA generated by the hydrolysis of the cross-linker provided by the present disclosure chelates with calcium and magnesium ions to prevent them from affecting the performance of the fracturing fluid. When the concentration of calcium and magnesium ions is relatively high, the hydrolysis equilibrium of the cross-linker is shifted to the right, which promotes the boronic acid group generated by the hydrolysis of the cross-linker to cross-link with guar gum, so the fracturing fluid system prepared using the cross-linker provided by the present disclosure has better salt resistance.

What is claimed is:

1. A salt-resistant guar gum fracturing fluid cross-linker aqueous solution, comprising water and a salt-resistant guar gum fracturing fluid cross-linker prepared by reacting a flue gas desulfurization and denitrification product with an aminocarboxylate complexing agent-based epoxyalkylboronate, wherein the flue gas desulfurization and denitrification product introduces a quaternary ammonium group for the cross-linker, the quaternary ammonium group is connected to an aminocarboxylate complexing agent-based epoxyalkylboronate group via a short carbon chain, and a boron atom in the boronate group is connected to the short carbon chain to form a boron-carbon bond;
specifically, the chemical formula of the salt-resistant guar gum fracturing fluid cross-linker is:

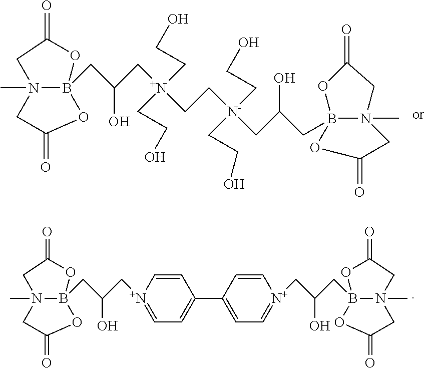

2. A method for preparing the salt-resistant guar gum fracturing fluid cross-linker aqueous solution according to claim 1, comprising the following steps:
S1. adding an aminocarboxylate complexing agent-based alkenylboronate to dichloromethane, stirring and cooling the mixture to obtain a suspension, adding peracetic acid to the suspension, heating and stirring the suspension to obtain a mixture, separating an organic phase, and subjecting the organic phase to drying, filtration, concentration under vacuum, and then purification by passing through a chromatographic column to obtain a desired crystalline solid, namely an aminocarboxylate complexing agent-based epoxyalkylboronate; and
S2. stirring and heating a flue gas desulfurization and denitrification product, then adding the crystalline solid prepared in step S1, dropwise adding deionized water, and reacting the mixture while the temperature is maintained to obtain the salt-resistant guar gum fracturing fluid cross-linker aqueous solution, wherein
the flue gas desulfurization and denitrification product is one of THEED sulfate, THEED nitrate, bipy sulfate, or bipy nitrate;
the aminocarboxylate complexing agent-based alkenylboronate is selected from allylboronic acid N-methyliminodiacetic acid ester; and
the molar ratio of the flue gas desulfurization and denitrification product to the aminocarboxylate complexing agent-based epoxyalkylboronate is 1:2.

3. The method for preparing the salt-resistant guar gum fracturing fluid cross-linker aqueous solution according to claim 2, wherein in step S1, the ratio of the dichloromethane to the aminocarboxylate complexing agent-based alkenylboronate is (15-25) L: 1 mol.

4. The method for preparing the salt-resistant guar gum fracturing fluid cross-linker aqueous solution according to claim 2, wherein in step S1, the temperature of the suspension is-10° C. to 0° C.;
the molar ratio of the added peracetic acid to the added aminocarboxylate complexing agent-based alkenylboronate is (3-4): 1; and
the heating and stirring are specifically heating to 20° C. to 40° C. and stirring for 15 to 20 h.

5. The method for preparing the salt-resistant guar gum fracturing fluid cross-linker aqueous solution according to claim 2, wherein in step S1, the specific operation of separating the organic phase comprises:
pouring the mixture into a separatory funnel containing a sodium bicarbonate solution, diluting the resulting mixed solution with ethyl acetate, then shaking the resulting dilution, separating an aqueous phase from an organic phase, extracting and separating the aqueous phase with ethyl acetate, and then washing the organic phase with a sodium bicarbonate solution.

6. The method for preparing the salt-resistant guar gum fracturing fluid cross-linker aqueous solution according to claim 2, wherein in step S1, a stationary phase in the chromatographic column is silica, and the solvent is a mixture of diethyl ether and acetonitrile at a volume ratio of 3:2.

7. The method for preparing the salt-resistant guar gum fracturing fluid cross-linker aqueous solution according to claim 2, wherein in step S2, stirring and heating to 25° C. to 50° C. are used, and the duration of the reaction at the maintained temperature is 0.5-3 h.

8. The method for preparing the salt-resistant guar gum fracturing fluid cross-linker aqueous solution according to claim 2, wherein in step S2, the prepared salt-resistant guar gum fracturing fluid cross-linker aqueous solution has a concentration of 100-700 mg/L.

9. A method of using the salt-resistant guar gum fracturing fluid cross-linker aqueous solution of claim 1, comprising: mixing the salt-resistant guar gum fracturing fluid cross-linker aqueous solution with a guar gum fracturing fluid; and injecting the salt-resistant guar gum fracturing fluid cross-linker aqueous solution mixed with the guar gum fracturing fluid into a formation, wherein a concentration of the salt-resistant guar gum fracturing fluid cross-linker in the salt-resistant guar gum fracturing fluid cross-linker aqueous solution is 100-700 mg/L.
